(19) United States
(12) Patent Application Publication
(10) Pub. No.: US 2026/0307387 A1
(43) Pub. Date: Oct. 8, 2026

(54) LIQUID DISCHARGE HEAD SUBSTRATE, LIQUID DISCHARGE HEAD, AND LIQUID DISCHARGE APPARATUS

(71) Applicant: CANON KABUSHIKI KAISHA, Tokyo (JP)

(72) Inventor: MAKOTO TAKAGI, Kanagawa (JP)

(21) Appl. No.: 19/456,681

(22) Filed: Jan. 22, 2026

(30) Foreign Application Priority Data
Jan. 23, 2025 (JP) 2025-009978

(51) Int. Cl. B41J 2/14

(52) U.S. Cl. CPC B41J 2/14072; B41J 2/14129; B41J 2002/14491

(57) ABSTRACT

A liquid discharge head substrate is provided. The liquid discharge head substrate includes: an element array including a plurality of liquid discharge elements arranged in a first direction; a heat generating portion arranged along the element array; and a driver configured to drive the heat generating portion. The heat generating portion comprises a first connecting portion located at one end portion in the first direction and connected to a first potential, a second connecting portion located at the other end portion in the first direction and connected to the first potential, and a third connecting portion located between the first connecting portion and the second connecting portion and connected to a second potential different from the first potential via the driver.

### BACKGROUND

### Field of the Technology

The present disclosure relates to a liquid discharge head substrate, a liquid discharge head, and a liquid discharge apparatus.

### Description of the Related Art

In a liquid discharge head substrate, if a temperature distribution occurs depending on a position in the liquid discharge head substrate, the amount of the discharge liquid or the discharge speed may vary, and image quality may degrade. Japanese Patent Laid-Open No. 2017-213874 shows that a plurality of heat generating portions are arranged along an array of heaters configured to discharge a liquid, thereby suppressing bias in a temperature distribution. Japanese Patent Laid-Open No. 2017-213874 also shows that to suppress temperature unevenness caused by heat generation of a driver that drives a heat generating portion, a plurality of drivers are arranged such that one driver corresponds to one heat generating portion.

In the configuration shown in Japanese Patent Laid-Open No. 2017-213874, since a driver is arranged in correspondence with each heat generating portion, the degree of freedom of layout design to arrange elements may be low.

### SUMMARY

Some embodiments of the present disclosure provide a technique advantageous in improving layout efficiency.

According to some embodiments, a liquid discharge head substrate comprising an element array including a plurality of liquid discharge elements arranged in a first direction; a heat generating portion arranged along the element array; and a driver configured to drive the heat generating portion, wherein the heat generating portion comprises a first connecting portion located at one end portion in the first direction and connected to a first potential, a second connecting portion located at the other end portion in the first direction and connected to the first potential, and a third connecting portion located between the first connecting portion and the second connecting portion and connected to a second potential different from the first potential via the driver, is provided.

Features of the present disclosure will become apparent from the following description of embodiments with reference to the attached drawings. The following description of embodiments is described by way of example.

### BRIEF DESCRIPTION OF THE DRAWINGS

FIG. 1 is a view showing an example of the configuration of a liquid discharge head substrate according to the embodiment;

FIGS. 2A and 2B are sectional views showing an example of the configuration of the liquid discharge head substrate shown in FIG. 1;

FIG. 3 is a circuit diagram showing an example of the configuration of the liquid discharge head substrate shown in FIG. 1;

FIG. 4 is a view showing a modification of the liquid discharge head substrate shown in FIG. 1;

FIG. 5 is a view showing a modification of the liquid discharge head substrate shown in FIG. 1;

FIG. 6 is a view showing a modification of the liquid discharge head substrate shown in FIG. 1;

FIG. 7 is a circuit diagram showing an example of the configuration of the liquid discharge head substrate shown in FIG. 6;

FIG. 8 is a sectional view showing an example of the configuration of the liquid discharge head substrate shown in FIG. 6; and

FIGS. 9A to 9D are views showing an example of the configuration of a liquid discharge apparatus using the liquid discharge head substrate shown in FIG. 1.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

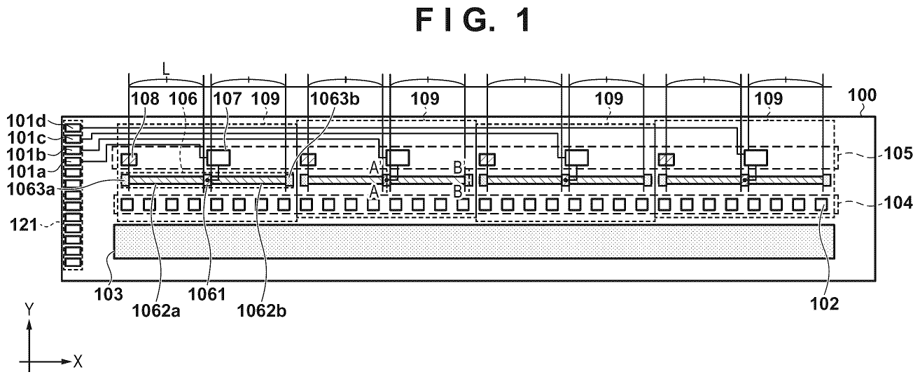

A liquid discharge head substrate according to the embodiment of the present disclosure will be described with reference to FIGS. 1 to 8. FIG. 1 is a schematic view schematically showing an example of the layout of a liquid discharge head substrate 100 according to this embodiment. The liquid discharge head substrate 100 includes an element array 104 including a plurality of liquid discharge elements 102 arranged in an X direction in FIG. 1, heat generating portions 106 arranged along the element array 104, and drivers 107 configured to drive the heat generating portions 106. In the configuration shown in FIG. 1, the X direction is the long side direction of the liquid discharge head substrate 100, and a Y direction is the short side direction of the liquid discharge head substrate 100. Also, a supply port 103 configured to supply, to the liquid discharge elements 102, a liquid to be discharged is provided in the liquid discharge head substrate 100 to supply the liquid to the upper layer of the liquid discharge elements 102. Although not illustrated in FIG. 1, discharge ports configured to discharge the liquid are arranged immediately above the liquid discharge elements 102. A liquid discharge head including the liquid discharge head substrate 100 and discharge ports is configured to heat the liquid discharge elements 102 at an arbitrary timing, thereby heating and foaming the liquid and discharging droplets from the discharge ports.

The heat generating portion 106 provided in the liquid discharge head substrate 100 is an element configured to heat the liquid discharge head substrate 100 and the liquid and keep these warm. The liquid discharge element 102 can also be called a heater, and the heat generating portion 106 can also be called a sub-heater. The driver 107 is connected to the heat generating portion 106. The driver 107 turns on or off the current to be supplied to the heat generating portion 106, thereby controlling the heat generating portion.

The liquid discharge head substrate 100 also includes a connecting terminal array 121 in which connecting terminals 101 configured to connect the liquid discharge head substrate 100 and the outside are arranged in the Y direction. As shown in FIG. 1, the connecting terminal array 121 may be arranged at an end portion of the liquid discharge head substrate 100 in the X direction. In the example shown in FIG. 1, the connecting terminal array 121 is arranged at one end portion of the liquid discharge head substrate 100 in the X direction, but may be arranged at each of both end portions. The connecting terminals 101 can include input terminals for data signals that selectively drive the liquid discharge elements 102 that discharge the liquid among the plurality of liquid discharge elements 102, and a power supply terminal. Furthermore, a temperature detection element 108 that measures the temperature of the liquid discharge head substrate 100 may be arranged on the liquid discharge head substrate 100.

In the configuration shown in FIG. 1, the region where the element array 104 is arranged is equally divided into four heating regions 109. In one heating region 109, some of the liquid discharge elements 102 forming the element array 104, one heat generating portion 106, one driver 107, and one temperature detection element 108 are arranged. Hence, the plurality of (four) heat generating portions 106 are provided along the element array 104. The drivers 107 provided in correspondence with the heat generating portions 106 are connected to connecting terminals 101a to 101d. The drivers 107 control the heat generating portions 106 in accordance with control signals input to the connecting terminals 101a to 101d. Each temperature detection element 108 is arranged at an appropriate position in the heating region 109 and detects the temperature of the liquid discharge head substrate 100 in the heating region 109. In this embodiment, an example in which four heating regions 109 (heat generating portions 106, drivers 107, and temperature detection elements 108) are arranged in the liquid discharge head substrate 100 is shown, but the number of heating regions 109 may be three or less or five or more. An appropriate number of heating regions 109 (heat generating portions 106, drivers 107, and temperature detection elements 108) can be arranged in accordance with the configuration of the liquid discharge head substrate 100.

To minimize routing of wiring patterns to the heat generating portions 106, the drivers 107 are arranged very close to the heat generating portions 106 and form a driver array 105. Hence, the plurality of drivers 107 can be arranged in the X direction such that these are arranged along the element array 104. Since driving elements of the liquid discharge elements 102 and control circuits (drivers) therefor can be arranged in each heating region 109, although not illustrated in FIG. 1, it is necessary to efficiently make a layout. The configuration of the heat generating portions 106 according to this embodiment for improving the layout efficiency will be described below.

The heat generating portion 106 includes a connecting portion 1063a that located at one end portion in the X direction and connected to a first potential, a connecting portion 1063b that is located at the other end portion in the X direction and connected to the first potential, like the connecting portion 1063a, and a connecting portion 1061 that is located between the connecting portion 1063a and the connecting portion 1063b and connected, via the driver 107, to a second potential different from the first potential. In addition, the heat generating portion 106 includes a resistor portion 1062a that is located between the connecting portion 1063a and the connecting portion 1061 and whose width in the Y direction crossing the X direction is different from that of the connecting portion 1063a and the connecting portion 1061, and a resistor portion 1062b that is located between the connecting portion 1063b and the connecting portion 1061 and whose width in the Y direction is different from that of the connecting portion 1063b and the connecting portion 1061. As shown in FIG. 1, the width (length) of the connecting portions 1063a, 1063b, and 1061 in the Y direction may be larger than the width of the resistor portions 1062a and 1062b in the Y direction. The heat generating portion 106 can be formed by one (integrated) pattern of polysilicon or the like, as will be described later, but the connecting portions 1063a, 1063b, and 1061 and the resistor portions 1062a and 1062b can be discriminated by the width difference. However, the configuration is not limited to this, and the heat generating portion 106 may have a predetermined width in the Y direction. In this case, the connecting portions 1063a, 1063b, and 1061 can be defined as, for example, positions where a via configured to supply the potential contacts the heat generating portion 106.

It can also be said that in the configuration shown in FIG. 1, the heat generating portion 106 is divided into two parts, that is, the resistor portion 1062a and the resistor portion 1062b by the connecting portion 1061 arranged at the center. The length of the resistor portion 1062a equals the length (distance) from the connecting portion 1061 to the connecting portion 1063a. Also, the length of the resistor portion 1062b equals the length from the connecting portion 1061 to the connecting portion 1063b. In the configuration shown in FIG. 1, the resistor portion 1062a and the resistor portion 1062b have the same length L in the X direction and also have the same width in the Y direction.

In this embodiment, all the resistor portions may have the same length, width, and material. With this configuration, the heat generation amounts of the resistor portions can be equal, and the whole chip can thus be heated evenly.

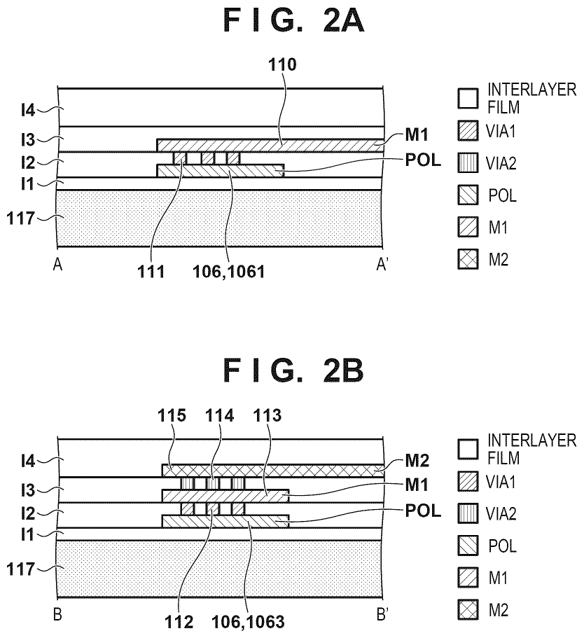

FIG. 2A is a sectional view showing the configuration of the connecting portion 1061 connecting the heat generating portion 106 and the driver 107, taken along a line A-A′ in FIG. 1. The configuration of conductive layers according to this embodiment will be described here. In the liquid discharge head substrate 100, insulating layers I1 to I4 and conductive layers POL, M1, and M2 are arranged. The insulating layer I1 is a layer closest to a substrate 117 in the insulating layers I1 to I4. The insulating layer I2 is arranged on the insulating layer I1, the insulating layer I3 is arranged on the insulating layer I2, and the insulating layer I4 is arranged on the insulating layer I3. The conductive layer POL is arranged between the insulating layer I1 and the insulating layer I2, the conductive layer M1 is arranged between the insulating layer I2 and the insulating layer I3, and the conductive layer M2 is arranged between the insulating layer I3 and the insulating layer I4. In the configuration shown in FIG. 2A, the four insulating layers I1 to I4 and the conductive layers POL, M1, and M2 arranged between the insulating layers I1 to I4 are shown. This is merely an example, and the liquid discharge head substrate 100 may be formed by fewer or more layers.

The conductive layers M1 and M2 may be patterned as needed and used wiring patterns. The conductive layers M1 and M2 can be made of, for example, copper-containing aluminum (AlCu). The conductive layer POL is made of, for example, polysilicon having a resistance higher than the conductive layers M1 and M2. The conductive layer POL is patterned and used as the heat generating portion 106. The insulating layers I1 to I4 are made using an insulating material, for example, a so-called silicon oxide based material such as silicon oxide, silicon nitride, or silicon oxynitride. The insulating layers I1 to I4 are arranged such that wiring patterns formed in the same layer or different layers are not short-circuited.

As shown in FIG. 2A, a wiring pattern 110 configured to connect the driver 107 and the connecting portion 1061 of the heat generating portion 106 is formed in the conductive layer M1. The wiring pattern 110 is connected to the connecting portion 1061 of the heat generating portion 106 via a via 111 provided in the insulating layer I2. It can also be said that the via 111 configured to supply the second potential is in contact with the connecting portion 1061 via the driver 107.

FIG. 2B is a sectional view showing the configuration of a connecting portion 1063 that supplies the first potential to the heat generating portion 106, taken along a line B-B′ in FIG. 1. The heat generating portion 106 formed in the conductive layer POL is connected, via vias 112 formed in the insulating layer I2, a wiring pattern 113 formed in the conductive layer M2, and via 114 formed in the insulating layer I3, to a wiring pattern 115 configured to supply the first potential. It can also be said that the via 112 configured to supply the first potential is in contact with the connecting portion 1063.

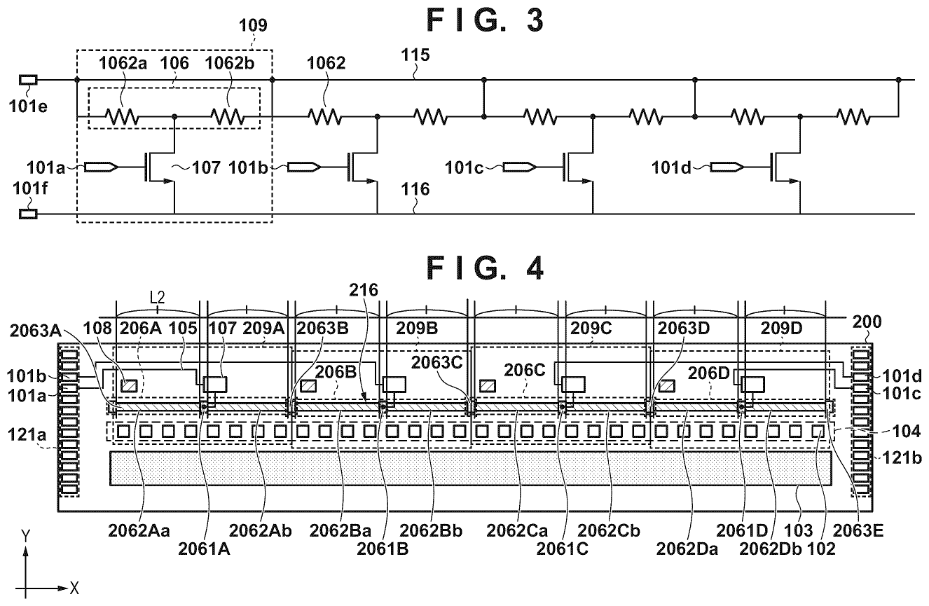

FIG. 3 is a view showing an example of the configuration of a circuit configured to drive the heat generating portion 106 in the liquid discharge head substrate 100 according to this embodiment. A connecting terminal 101e is a power supply terminal to which the first potential (for example, a positive potential) is applied, and is used of supply power to the heat generating portion 106 via the wiring pattern 115 and the like, as described above. The wiring pattern 115 is connected to one-end sides of the resistor portions 1062a and 1062b via the vias 114, the wiring pattern 113, the vias 112, and the connecting portions 1063a and 1063b (not illustrated in FIG. 3 for the sake of simplicity), as described above. The other-end sides of the resistor portions 1062a and 1062b are commonly connected to a switch element (for example, the drain terminal of an NMOS transistor) used as the driver 107 via the connecting portion 1061 (not illustrated in FIG. 3 for the sake of simplicity). The source terminal of the NMOS transistor used as the driver 107 is connected to a connecting terminal 101f via a wiring pattern 116 configured to supply the second potential. The connecting terminal 101f is a power supply terminal to which the second potential (for example, ground potential) is applied. The gate terminal of the NMOS transistor used as the driver 107 is connected to the connecting terminals 101a to 101d. It is possible to drive the resistor portions 1062a and 1062b of the heat generating portion 106 in accordance with the logic of a signal and heat an arbitrary one of the four heating regions 109 in the liquid discharge head substrate 100.

The effect of this embodiment will be described here. Using the length L [m] of the resistor portion 1062 in the X direction, a necessary heat generation amount H [W], a sheet resistance ρs [Ω/□] of the resistor, and a power supply voltage V [V] that is the potential difference between the first potential and the second potential, a width W [m] of the resistor portion 1062 in the Y direction is expressed as

W=H×ρs×L/V² (1)

In this embodiment, the resistor portion 1062a and the resistor portion 1062b of the heat generating portion 106 are connected in parallel between the wiring pattern 115 and the driver 107. Consider that the same heat generation amount H should be obtained in the configuration according to this embodiment and a configuration (comparative example) in which the connecting portion 1063 connected to the first potential and the connecting portion 1061 connected to the second potential via the driver 107 are provided at the two ends of a resistor having the same length as the heat generating portion 106. In this case, the heat generating portion 106 according to this embodiment is divided into the resistor portions 1062a and 1062b whose heat generation amount and length are ½ as compared to the comparative example. For this reason, the width of the resistor portions 1062a and 1062b can be ¼ that of the comparative example. Also, with this configuration, the two resistor portions 1062a and 1062b obtained by dividing the heat generating portion 106 can be controlled by one consolidated driver 107. In the configuration according to this embodiment, it is possible to further consolidate the drivers 107 while reducing the width of the heat generating portions 106 in the Y direction. Hence, the layout efficiency for arranging elements when designing the liquid discharge head substrate 100 improves.

In the liquid discharge head substrate 100 according to this embodiment, it has been explained that the gate terminal of the NMOS transistor used as the driver 107 is controlled by a logic signal input from the outside via the connecting terminals 101a to 101d. However, the present disclosure is not limited to this. For example, a control circuit may be provided on the liquid discharge head substrate 100, and each driver 107 may be controlled in accordance with a temperature detected by the temperature detection element 108, or the like.

As described above, in this embodiment, the width of the connecting portion 1061, 1063a, and 1063b in the Y direction is wider than the width of the resistor portions 1062a and 1062b in the Y direction. The number of vias 111 and 112 that are in contact with the connecting portions 1061, 1063a, and 1063b is decided depending on the amount of the current supplied to the resistors forming the heat generating portion 106. By adjusting the width of the connecting portions 1061, 1063a, and 1063b in the Y direction, an appropriate number of vias 111 and 112 can be arranged, and the density of the current flowing through the vias 111 and 112 can appropriately be designed. For example, the number of vias 111 that are in contact with the connecting portion 1061 may be larger than the number of vias connected to the connecting portions 1063a and 1063b. This is because the two resistor portions 1062a and 1062b are connected to the connecting portion 1061. Hence, for example, the width of the connecting portion 1061 in the Y direction may be wider than the width of the connecting portions 1063a and 1063b in the Y direction. Also, as described above, the width of the connecting portions 1061, 1063a, and 1063b in the Y direction need not necessarily be wider than the width of the resistor portions 1062a and 1062b. For example, the connecting portions 1063a and 1063b and the resistor portions 1062a and 1062b may have the same width in the Y direction, and the connecting portion 1061 may have a wider width in the Y direction than the connecting portions 1063a and 1063b and the resistor portions 1062a and 1062b.

Also, in this embodiment, the resistor portion 1062a and the resistor portion 1062b are configured to have the same length L. Based on equation (1) described above, with this configuration, the resistor portion 1062a and the resistor portion 1062b can have the minimum width. On the other hand, there may be a case where the resistor portion 1062a and the resistor portion 1062b cannot have the same length because of the wiring pattern from the heat generating portion 106 formed in the conductive layer POL to the wiring pattern 115 arranged in the upper layer or the extraction position of the wiring pattern to the driver 107. If the wiring pattern between the liquid discharge elements 102 that are generally arranged at equal pitches and the driving circuits thereof is avoided, it is assumed that the lengths of the resistor portions 1062a and 1062b can be selected only based on the pitch to arrange the liquid discharge elements 102. For this reason, even if the lengths of the two resistor portion 1062a and 1062b cannot be designed equal, the width of the longer resistor portion 1062 in the Y direction (=the maximum width necessary for the resistor portion 1062) can be minimized by minimizing the difference between the numbers of liquid discharge elements 102 adjacent to the resistor portions 1062a and 1062b (to 1 or less if possible). That is, the difference between the lengths of the resistor portions 1062a and 1062b forming one heat generating portion 106 may be equal to or less than the pitch to arrange the plurality of liquid discharge elements 102 along the X direction. Also, for example, the difference between the length from a portion of the connecting portion 1063a in contact with the via 112 to a portion of the connecting portion 1061 in contact with the via 111 and the length from a portion of the connecting portion 1063b in contact with the via 112 to the portion of the connecting portion 1061 in contact with the via 111 may be equal to or less than the pitch to arrange the plurality of liquid discharge elements 102 along the X direction. If the plurality of vias 111 and 112 are arranged as described above, for example, comparison may be done based on the length between the vias 111 and 112 arranged at the center in the Y direction or the longest (shortest) length between the vias 111 and 112.

Also, in this embodiment, the liquid discharge head substrate 100 is configured such that the plurality of heat generating portions 106 are arranged along the element array 104 and an arbitrary heating region 109 can be heated. With this configuration, even if a temperature difference is generated between the heating regions 109 due to the difference of the discharge frequency in the element array 104, it is possible to control to make the temperature of the liquid discharge head substrate 100 more even. It is therefore possible to implement the liquid discharge head substrate 100 capable of performing high-quality print. However, the present disclosure is not limited to this and, for example, a plurality of element arrays 104 may be provided, and one heating region 109 with one heat generating portion 106 may be provided for each element array.

In the above-described embodiment, the layout efficiency is high because the drivers 107 can be consolidated while reducing the width of the resistor portions 1062 of the heat generating portions 106 in the Y direction on the liquid discharge head substrate 100. On the other hand, the heat generating portions 106 break between the plurality of heating regions 109, and the liquid discharge head substrate 100 has regions where the heat generating portions 106 are not arranged. Hence, it may be difficult to uniformly heat the element array 104 without unevenness.

FIG. 4 is a schematic view showing an example of the configuration of a liquid discharge head substrate 200 that is a modification of the liquid discharge head substrate 100 shown in FIG. 1. Points different from the above-described configuration will mainly be described below, and a description of components that can be the same will appropriately be omitted.

In this embodiment as well, four heating regions 209 each including a heat generating portion 206 are arranged, like the configuration shown in FIG. 1. On the other hand, in the configuration shown in FIG. 4, heat generating portions 206A to 206D are formed integrally along the element array 104. That is, a resistor pattern 216 extending along the element array 104 is arranged on the liquid discharge head substrate 200, and the plurality of heat generating portions 206 form parts of the resistor pattern 216. In the heat generating portions 206 adjacent to each other, a connecting portion 2063 of one heat generating portion 206 and the connecting portion 2063 of the other heat generating portion 206 share the same connecting portion 2063. As shown in FIG. 4, a connecting portion 2063A of the heat generating portion 206A and a connecting portion 2063E of the heat generating portion 206D are arranged at the two ends of the integrally formed resistor pattern 216. Between these, connecting portions 2061A to 2061D connected to the second potential via the drivers 107 and connecting portions 2063B to 2063D connected to the first potential are alternately arranged.

As for each heat generating portion 206, at the boundary between the heat generating portion 206A and the heat generating portion 206B, the connecting portion 2063B is shared by the heat generating portion 206A and the heat generating portion 206B. Similarly, at the boundary between the heat generating portion 206B and the heat generating portion 206C, the connecting portion 2063C is shared by the heat generating portion 206B and the heat generating portion 206C. Also, similarly, at the boundary between the heat generating portion 206C and the heat generating portion 206D, the connecting portion 2063D is shared by the heat generating portion 206C and the heat generating portion 206D. Each of the connecting portions 2061A to 2061D is arranged at the central part (for example, the center position) between two connecting portions 2063 arranged at the two ends of a corresponding one of the heat generating portions 206A to 206D, as in the above-described embodiment. The heat generating portions 206A to 206D are connected to different drivers and can therefore be driven independently.

Each of the connecting portions 2063B to 2063D is shared by two heat generating portions 206, and it can be said that each of the heating regions 209 arranged in the X direction contacts the adjacent heating region at the central part of the connecting portion 2063. Like the configuration shown in FIG. 1, the temperature detection element 108 and the driver 107 can be arranged in each heating region 209. Also, like the configuration shown in FIG. 1, the heat generating portions 206A to 206D are divided into resistor portions 2062Aa to 2062Da and resistor portions 2062Ab to 2062Db at the connecting portions 2061A to 2061D. In the configuration shown in FIG. 4, the resistor portions 2062Aa to 2062Db have equal lengths L2. However, as described above, it may be impossible to cause all the resistor portions 2062Aa to 2062Da to have the same length because of the arrangement of the elements on the liquid discharge head substrate 200. In this case, the difference of the lengths of the resistor portions 2062Aa to 2062Db may be equal to or less than the pitch to arrange the plurality of liquid discharge elements 102 along the X direction. Also, as described above, between the heat generating portions 206, the difference of the length between the via 111 in contact with the connecting portion 2061 and the via 112 in contact with the connecting portion 2063 may be equal to or less than the pitch to arrange the plurality of liquid discharge elements 102 along the X direction. Furthermore, the heat generating portions 206 may have the same length between the via 111 in contact with the connecting portion 2061 and the via 112 in contact with the connecting portion 2063.

This embodiment is different from the configuration shown in FIG. 1 in that the heat generating portions 206A to 206D are integrated (resistor pattern 216) on the layout such that these do not break in a planar view and an arbitrary heat generating portion 206 among the heat generating portions 206A to 206D is caused to generate heat. The plurality of heat generating portions 206A to 206D are continuously arranged along the element array 104 so that there is no region where the resistor pattern breaks and heat is not generated. For this reason, heat can be generated even at the boundaries between the heating regions 209A to 209D. As a result, it is possible to uniformly heat the element array 104 without unevenness more than the configuration shown in FIG. 1.

Additionally, in the configuration shown in FIG. 1, the connecting terminal array 121 is arranged at one end of the liquid discharge head substrate 100 in the X direction. On the other hand, in the configuration shown in FIG. 4, a connecting terminal array 121a and a connecting terminal array 121b are arranged at the two ends of the liquid discharge head substrate 200 along two sides in the Y direction. This can improve the degree of freedom in routing wiring patterns to the connecting terminals 101 arranged in the connecting terminal arrays 121a and 121b. In the example shown in FIG. 4, of the connecting terminals 101a to 101d connected to the gate terminals of the NMOS transistors used as the drivers 107, the connecting terminals 101a and 101b are arranged in the connecting terminal array 121a, and the connecting terminals 101c and 101d are arranged in the connecting terminal array 121b.

In the configuration shown in FIG. 4, all the heat generating portions 206 provided along the element array 104 are formed as the integrated resistor pattern 216, the resistor pattern 216 is divided into four regions, and these are configured to be driven as the heat generating portions 206A to 206D. However, the present disclosure is not limited to this. For example, two integrated heat generating portions 206 may be provided to be driven in the regions such that the heat generating portions 206 are divided at the central part of the liquid discharge head substrate 200 in the X direction. The number of heat generating portions 206 forming one resistor pattern 216 may be three or five or more. The connecting portions 2063 connected to the first potential are located at the two ends of one resistor pattern 216, and between these, the connecting portions 2061 connected to the second potential via the drivers 107 and the connecting portions 2063 connected to the first potential are alternately arranged. One resistor pattern 216 is thus divided into an appropriate number of heat generating portions 206.

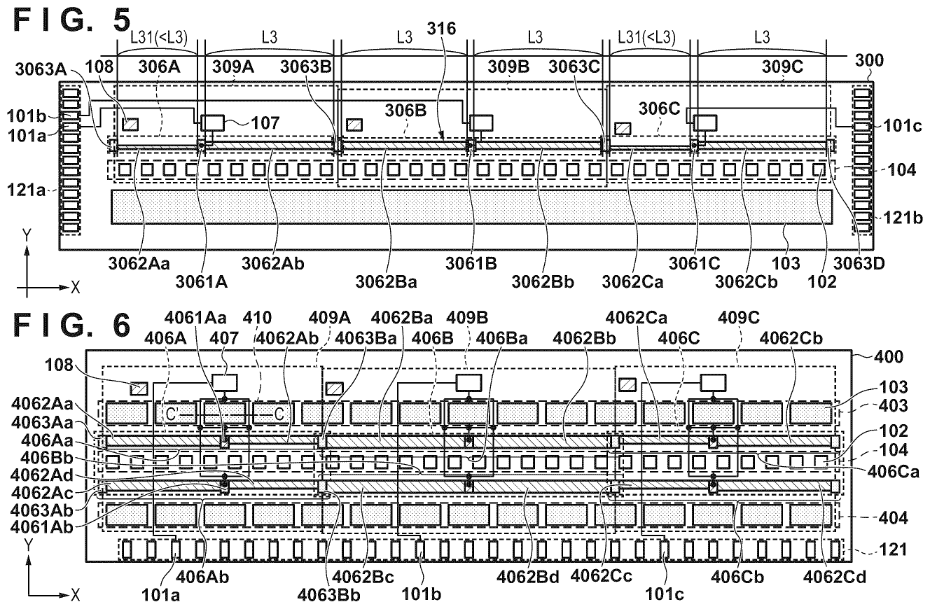

FIG. 5 is a schematic view showing an example of the configuration of a liquid discharge head substrate 300 that is a modification of the liquid discharge head substrate 200 shown in FIG. 4. In the liquid discharge head substrate 200 shown in FIG. 4, the plurality of heat generating portions 206A to 206D (resistor portions 2062Aa to 2062Db) having the same length in the X direction are arranged. On the other hand, in the liquid discharge head substrate 300 shown in FIG. 5, a plurality of heat generating portions 306 having different lengths in the X direction are arranged along the element array 104. Points different from the above-described configuration will mainly be described below, and a description of components that can be the same will appropriately be omitted.

In the configuration shown in FIG. 5, a plurality of heat generating portion 306A to 306C are configured to form parts of one resistor pattern 316 and selectively generate heat, like the configuration shown in FIG. 4. On the other hand, the length of the heat generating portion 306B in the X direction is longer than that of the heat generating portions 306A and 306C. In this point, the liquid discharge head substrate 300 is different from the liquid discharge head substrate 200.

In this embodiment, the heat generating portion 306B that is longest in the X direction is divided, at a connecting portion 3061B, into resistor portions 3062Ba and 3062Bb having the same length L3. A resistor portion 3062Ab of the heat generating portion 306A and a resistor portion 3062Cb of the heat generating portion 306C are each also configured to have the length L3. On the other hand, resistor portions 3062Aa and 3062Ca of the heat generating portions 306A and 306C each have a length L31. Here, the length L31 is shorter than the length L3 (L31<L3). To make the heat generation amounts per unit length of the heat generating portions 306A to 306C (the resistor portions 3062Aa to 3062Cb) match, the Y-direction width of the resistor portions 3062Aa and 3062Ca with the short length L31 is narrower than the Y-direction width of the resistor portions 3062Ab, 3062Ba, 3062Bb, 3062Cb with the length L3.

Focusing on the longest heat generating portion 306B, the resistor portion 3062Ba and the resistor portion 3062Bb are designed such that the length of the heat generating portion is equally divided into two parts. The heat generating portion 306 arranged to extend in the X direction along the element array 104 can thus be designed such that its maximum width in the Y direction is minimized. As for resistor portions 3062 of the heat generating portions 306 other than the longest heat generating portion 306, the resistor pattern 316 is divided at connecting portions 3061 and 3063 such that the resistor portions have a length equal to or less than the length of the resistor portions 3062 of the longest heat generating portion 306. This never affects the maximum width of the heat generating portions 306 in the Y direction.

The number of liquid discharge elements 102 in the element array 104 is mainly decided from the specification “the print length of the liquid discharge head substrate”, and it may be impossible to evenly divide the length of the heat generating portion 106 arranged along the element array 104. According to this embodiment, focusing on the longest heat generating portion 306B among the plurality of heat generating portions 306, the resistor portion 3062Ba and the resistor portion 3062Bb are designed to minimize the width in the Y direction, and the lengths of the remaining resistor portions 3062 are then decided. For this reason, for the plurality of heat generating portions 306 arranged along the element array 104, even if the lengths in the X direction are uneven, the width of the heat generating portion 306 in the Y direction can be designed minimum.

As described in this embodiment, the width of each resistor portion may be adjusted in accordance with the length of the resistor portion. With this configuration, even if the heat generating portion 106 includes a plurality of resistors with different widths, the resistor portions can be configured to generate heat in the same amount.

In the configuration shown in FIG. 5, resistor portions having the same length as the resistor portions 3062Ba and 3062Bb that have the length L3 and are arranged to divide the longest heat generating portion 306B into two equal parts are applied to the resistor portions 3062Ab and 3062Cb of the heat generating portions 306A and 306C. Furthermore, the length of the other resistor portions 3062Aa and 3062Ca in the X direction is made short, and the width in the Y direction is made narrow. However, the present disclosure is not limited to this. The widths of the resistor portions 3062Aa, 3062Ab, 3062Ca, and 3062Cb of the heat generating portions 306A and 306C may freely be selected without exceeding the Y-direction width of the resistor portions 3062Ba and 3062Bb of the heat generating portion 306B. Also, on the liquid discharge head substrate 300 shown in FIG. 5, as described above, in the heat generating portions 306 adjacent to each other, the length of one resistor portion 3062 of the four resistor portions 3062 is short, and the width in the Y direction is narrow. However, in the heat generating portions 306 adjacent to each other, the length of one resistor portion 3062 of the four resistor portions 3062 may be long and the width in the Y direction may be wide by the arrangement of the other constituent elements of the liquid discharge head substrate.

In the above-described liquid discharge head substrates 100 to 300, configurations in which in correspondence with one element array 104, the heat generating portions 106, 206, and 306 are provided on the opposite side of the supply port 103 configured to supply a liquid have been described. However, the present disclosure is not limited to this. The heat generating portions may be arranged on both sides of the element array 104. FIG. 6 is a schematic view showing an example of the configuration of a liquid discharge head substrate 400 in which heat generating portions 406 are arranged on both sides of the element array 104 in the Y direction. Points different from the above-described configurations will mainly be described below, and a description of components that can be the same will appropriately be omitted.

On the liquid discharge head substrate 400, a supply port array 403 and a supply port array 404, in each of which the plurality of supply ports 103 configured to supply the liquid to the liquid discharge elements 102 are arranged in the X direction, are arranged such that the element array 104 is sandwiched. A heat generating portion 406A arranged in correspondence with one heating region 409A includes a heat generating portion 406Aa and a heat generating portion 406Ab, which are controlled by one driver 407A. The element array 104 is arranged between the heat generating portion 406Aa and the heat generating portion 406Ab. A resistor portion 4062 of the heat generating portion 406A is divided into four regions. More specifically, a resistor portion 4062Aa and a resistor portion 4062Ac, which form the heat generating portion 406Aa, and a resistor portion 4062Ab and a resistor portion 4062Ad, which form the heat generating portion 406Ab, are arranged facing each other across the element array 104. The supply port array 403 is arranged between the heat generating portion 406A and the driver 407A, and the driver 407A and connecting portions 4061Aa and 4061Ab are connected via a wiring pattern 410. As shown in FIG. 6, the wiring patterns 410 may be electrically parallelly arranged in two or more regions in regions between the supply ports 103 adjacent to each other in the supply port array 403. A heat generating portion 406B and a heat generating portion 406C can also similarly be configured.

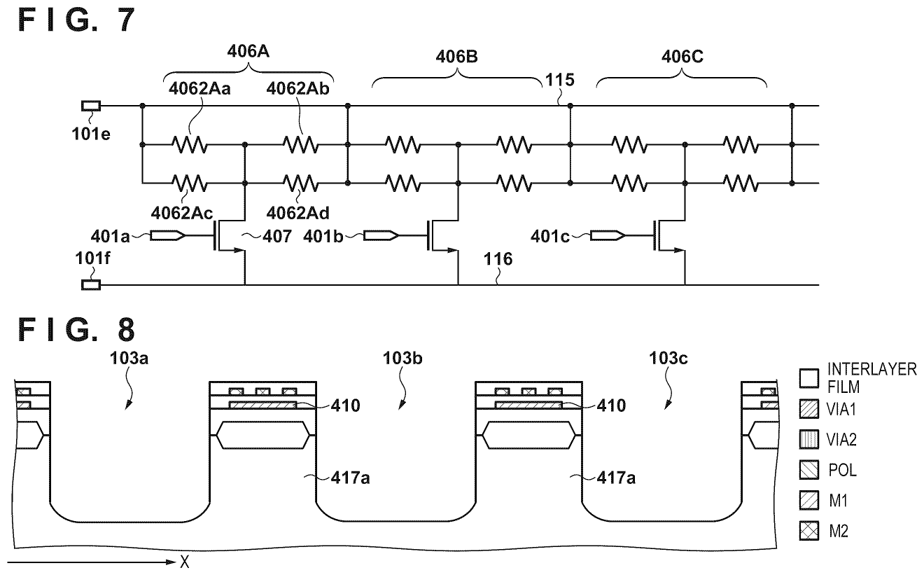

FIG. 7 is a view showing an example of the configuration of a circuit configured to drive the heat generating portions 406 on the liquid discharge head substrate 400 shown in FIG. 6. The connecting terminal 101e is a power supply terminal to which the first potential (for example, a positive potential) is applied, and is connected in parallel to one-end sides of the resistor portions 4062 via the wiring pattern 115 and the like, as described above. The other-end sides of the resistor portions 4062 are connected in parallel to a switch element (for example, the drain terminal of an NMOS transistor) used as the driver 407. The source terminal of the NMOS transistor used as the driver 407 is connected to the connecting terminal 101f via the wiring pattern 116 configured to supply the second potential. The connecting terminal 101f is a power supply terminal to which the second potential (for example, ground potential) is applied. The gate terminal of the NMOS transistor used as the driver 407 is connected to a connecting terminal 401. It is possible to drive the resistor portions 4062 of the heat generating portions 406A to 406C in accordance with the logic of a signal and heat an arbitrary one of three heating regions 409 in the liquid discharge head substrate 400.

FIG. 8 is a sectional view showing the configuration of the liquid discharge head substrate 400 taken along a line C-C′ in FIG. 6. The liquid discharge head substrate 400 can be formed using a silicon substrate or the like. Hence, as shown in FIG. 8, a silicon structure 417a is formed between a supply port 103a and a supply port 103b. Similarly, a silicon structure 417b is formed between the supply port 103b and a supply port 103c. The wiring pattern 410 that connects the driver 407A and the connecting portions 4061Aa and 4061Ab of the heat generating portion 406A is divided onto the silicon structure 417a and the silicon structure 417b, and the divided wiring patterns 410 are electrically parallelly arranged. Hence, even if a large current flows through the heat generating portion 406, the current density of each wiring pattern 410 can be lowered. That is, occurrence of electromigration in the wiring pattern 410 is suppressed, and the reliability of the liquid discharge head substrate 400 can be improved.

In the configuration shown in FIG. 6, the resistor portions 4062 that have three types of X-direction lengths and Y-direction widths are arranged. More specifically, the resistor portions 4062Ab, 4062Ad, 4062Ca, and 4062Cc have the shortest length and the narrow width. On the other hand, the resistor portions 4062Ba to 4062Bd have the longest length and the narrow width. The resistor portions 4062Aa, 4062Ac, 4062Cb, and 4062Cd have the intermediate length and width. However, the lengths and widths of the resistor portions 4062 (the lengths and widths between the vias 111 and 112) are not limited to these and can appropriately be adjusted in accordance with the design of the liquid discharge head substrate. Also, the configurations of the above-described liquid discharge head substrates 100 to 400 may appropriately be combined and used. For example, like the liquid discharge head substrate 100, in each independent heat generating portion 106, the X-direction length or Y-direction width of the resistor portion 1062 may differ between the heat generating portions 106, like the liquid discharge head substrates 300 and 400.

### Other Embodiments

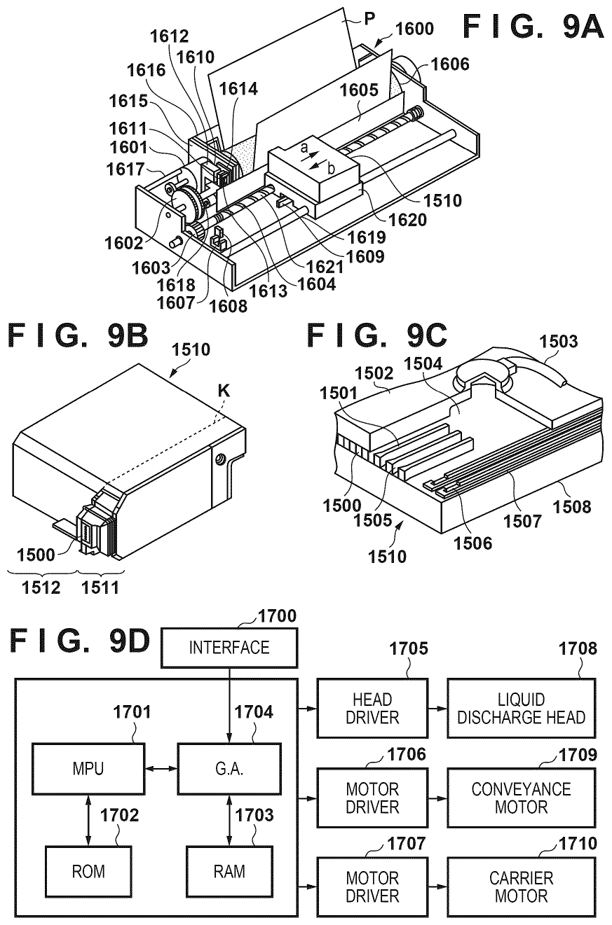

A liquid discharge apparatus using one of the above-described liquid discharge head substrates 100 to 400 will be explained here with reference to FIGS. 9A to 9D. FIG. 9A exemplifies the internal configuration of a liquid discharge apparatus 1600 typified by an inkjet printer, a facsimile apparatus, or a copying machine. In this example, the liquid discharge apparatus may also be called a printing apparatus. The liquid discharge apparatus 1600 includes a liquid discharge head 1510 that discharges a liquid (in this example, ink or a printing material) to a predetermined medium P (in this example, a print medium such as paper). In this example, the liquid discharge head may also be called a printhead. The liquid discharge head 1510 is mounted on a carriage 1620, and the carriage 1620 can be attached to a lead screw 1621 having a helical groove 1604. The lead screw 1621 can rotate in synchronization with rotation of a driving motor 1601 via driving force transmission gears 1602 and 1603. The liquid discharge head 1510 can move in a direction indicated by an arrow a or b along a guide 1619 together with the carriage 1620.

The medium P is pressed by a paper press plate 1605 in the carriage moving direction and fixed to a platen 1606. The liquid discharge apparatus 1600 performs liquid discharge (in this example, print) to the medium P conveyed on the platen 1606 by a conveyance unit (not shown) by reciprocating the liquid discharge head 1510.

The liquid discharge apparatus 1600 confirms the position of a lever 1609 provided on the carriage 1620 via photocouplers 1607 and 1608, and switches the rotational direction of the driving motor 1601. A support member 1610 supports a cap member 1611 for covering the nozzle (a liquid discharge port or simply a discharge port) of the liquid discharge head 1510. A suction portion 1612 performs recovery processing of the liquid discharge head 1510 by sucking the interior of the cap member 1611 via an intra-cap opening 1613. A lever 1617 is provided to start recovery processing by suction, and moves along with movement of a cam 1618 engaged with the carriage 1620. A driving force from the driving motor 1601 is controlled by a well-known transmission mechanism such as a clutch switch.

A main body support plate 1616 supports a moving member 1615 and a cleaning blade 1614. The moving member 1615 moves the cleaning blade 1614 to perform recovery processing of the liquid discharge head 1510 by wiping. The liquid discharge apparatus 1600 includes a controller (not shown) and the controller controls driving of each mechanism described above.

FIG. 9B exemplifies the outer appearance of the liquid discharge head 1510. The liquid discharge head 1510 can include a head portion 1511 having a plurality of nozzles 1500, and a tank (liquid storage portion) 1512 that holds a liquid to be supplied to the head portion 1511. The tank 1512 and the head portion 1511 can be separated at, for example, a broken line K and the tank 1512 is interchangeable. The liquid discharge head 1510 has an electrical contact (not shown) for receiving an electrical signal from the carriage 1620 and discharges a liquid in accordance with the electrical signal. The tank 1512 has a fibrous or porous liquid holding member (not shown) and the liquid holding member can hold a liquid.

FIG. 9C exemplifies the internal configuration of the liquid discharge head 1510. The liquid discharge head 1510 includes a base 1508, flow path wall members 1501 that are arranged on the base 1508 and form flow paths 1505, and a top plate 1502 having a liquid supply path 1503. The base 1508 may be one of the above-described liquid discharge head substrates 100 to 400. As discharge elements or liquid discharge elements, heaters 1506 (which can also be referred to as electrothermal transducers or heat generating resistive elements) are arrayed on the substrate (liquid discharge head substrate) of the liquid discharge head 1510 in correspondence with the respective nozzles 1500. Each heater 1506 is driven to generate heat by turning on a driving element (a switching element such as a transistor) provided in correspondence with the heater 1506.

A liquid from the liquid supply path 1503 is stored in a common liquid chamber 1504 and supplied to each nozzle 1500 via the corresponding flow path 1505. The liquid supplied to each nozzle 1500 is discharged from the nozzle 1500 in response to driving of the heater 1506 corresponding to the nozzle 1500.

FIG. 9D exemplifies the system configuration of the liquid discharge apparatus 1600. The liquid discharge apparatus 1600 includes an interface 1700, an MPU 1701, a ROM 1702, a RAM 1703, and a gate array (G.A.) 1704. The interface 1700 receives from the outside an external signal for executing liquid discharge. The ROM 1702 stores a control program to be executed by the MPU 1701. The RAM 1703 saves various signals and data such as the above-mentioned external signal for liquid discharge and data supplied to the liquid discharge head 1708. The gate array 1704 performs supply control of data to the liquid discharge head 1708 and control of data transfer between the interface 1700, the MPU 1701, and the RAM 1703.

The liquid discharge apparatus 1600 further includes a head driver 1705, motor drivers 1706 and 1707, a conveyance motor 1709, and a carrier motor 1710. The carrier motor 1710 conveys a liquid discharge head 1708. The conveyance motor 1709 conveys the medium P. The head driver 1705 drives the liquid discharge head 1708. The motor drivers 1706 and 1707 drive the conveyance motor 1709 and the carrier motor 1710, respectively.

When a driving signal is input to the interface 1700, it can be converted into data for liquid discharge between the gate array 1704 and the MPU 1701. Each mechanism performs a desired operation in accordance with this data. In this manner, the liquid discharge head 1708 is driven.

According to the present disclosure, it is possible to provide a technique advantageous in improving layout efficiency.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-009978, filed Jan. 23, 2025, which is hereby incorporated by reference herein in its entirety.

What is claimed is:

1. A liquid discharge head substrate comprising:
an element array including a plurality of liquid discharge elements arranged in a first direction;
a heat generating portion arranged along the element array; and
a driver configured to drive the heat generating portion,
wherein the heat generating portion comprises a first connecting portion located at one end portion in the first direction and connected to a first potential, a second connecting portion located at the other end portion in the first direction and connected to the first potential, and a third connecting portion located between the first connecting portion and the second connecting portion and connected to a second potential different from the first potential via the driver.

2. The substrate according to claim 1, wherein the heat generating portion comprises a first resistor portion which is located between the first connecting portion and the third connecting portion and whose width in a second direction crossing the first direction is different from that of the first connecting portion and the third connecting portion, and a second resistor portion which is located between the second connecting portion and the third connecting portion and whose width in the second direction is different from that of the second connecting portion and the third connecting portion.

3. The substrate according to claim 2, wherein the width of the first connecting portion, the second connecting portion, and the third connecting portion in the second direction is wider than the width of the first resistor portion and the second resistor portion in the second direction.

4. The substrate according to claim 2, wherein a difference between a length of the first resistor portion and a length of the second resistor portion is not more than a pitch to arrange the plurality of liquid discharge elements along the first direction.

5. The substrate according to claim 2, wherein a length of the first resistor portion and a length of the second resistor portion are equal.

6. The substrate according to claim 2, wherein a length of the first resistor portion is longer than a length of the second resistor portion, and
a width of the first resistor portion in the second direction is wider than width of the second resistor portion in the second direction.

7. The substrate according to claim 1, wherein a first via configured to supply the first potential is in contact with the first connecting portion,
a second via configured to supply the first potential is in contact with the second connecting portion,
a third via configured to supply the second potential is in contact with the third connecting portion via the driver, and
a difference between a length from a portion of the first connecting portion in contact with the first via to a portion of the third connecting portion in contact with the third via and a length from a portion of the second connecting portion in contact with the second via to the portion of the third connecting portion in contact with the third via is not more than a pitch to arrange the plurality of liquid discharge elements along the first direction.

8. The substrate according to claim 1, wherein a plurality of supply ports configured to supply a liquid to the plurality of liquid discharge elements are arranged along the first direction,
the plurality of supply ports are arranged between the heat generating portion and the driver, and
wiring patterns that connect the driver and the third connecting portion are electrically parallelly arranged in not less than two regions of regions between supply ports adjacent to each other.

9. The substrate according to claim 8, further comprising a second heat generating portion,
wherein the element array is arranged between the heat generating portion and the second heat generating portion, and
the second heat generating portion comprises:
a fourth connecting portion located at one end portion in the first direction and connected to the first potential;
a fifth connecting portion located at the other end portion in the first direction and connected to the first potential; and
a sixth connecting portion located between the first connecting portion and the second connecting portion and connected to the driver via the wiring pattern.

10. The substrate according to claim 1, wherein a plurality of heat generating portions including the heat generating portion are arranged along the element array.

11. The substrate according to claim 10, wherein a plurality of drivers including the driver are arranged in correspondence with the plurality of heat generating portions, respectively.

12. The substrate according to claim 11, wherein the plurality of drivers are arranged along the first direction.

13. The substrate according to claim 10, wherein a resistor pattern extending along the element array is arranged, and
the plurality of heat generating portions form parts of the resistor pattern.

14. The substrate according to claim 13, wherein the plurality of heat generating portions includes a third heat generating portion and a fourth heat generating portion, which are arranged adjacent to each other, and
the first connecting portion of the third heat generating portion and the second connecting portion of the fourth heat generating portion share the same connecting portion.

15. The substrate according to claim 10, wherein each of the plurality of heat generating portions comprises a first resistor portion which is located between the first connecting portion and the third connecting portion and whose width in a second direction crossing the first direction is different from that of the first connecting portion and the third connecting portion, and a second resistor portion which is located between the second connecting portion and the third connecting portion and whose width in the second direction is different from that of the second connecting portion and the third connecting portion,
the plurality of heat generating portions include a fifth heat generating portion and a sixth heat generating portion, and
a difference between a length of the first resistor portion of the fifth heat generating portion, a length of the second resistor portion of the fifth heat generating portion, a length of the first resistor portion of the sixth heat generating portion, and a length of the second resistor portion of the sixth heat generating portion is not more than a pitch to arrange the plurality of liquid discharge elements along the first direction.

16. The substrate according to claim 15, wherein the length of the first resistor portion of the fifth heat generating portion, the length of the second resistor portion of the fifth heat generating portion, the length of the first resistor portion of the sixth heat generating portion, and the length of the second resistor portion of the sixth heat generating portion equal.

17. The substrate according to claim 10, wherein each of the plurality of heat generating portions comprises a first resistor portion which is located between the first connecting portion and the third connecting portion and whose width in a second direction crossing the first direction is different from that of the first connecting portion and the third connecting portion, and a second resistor portion which is located between the second connecting portion and the third connecting portion and whose width in the second direction is different from that of the second connecting portion and the third connecting portion,
the plurality of heat generating portions include a fifth heat generating portion and a sixth heat generating portion,
a length of the first resistor portion of the fifth heat generating portion is longer than a length of the second resistor portion of the fifth heat generating portion, a length of the first resistor portion of the sixth heat generating portion, and a length of the second resistor portion of the sixth heat generating portion, and
a width of the first resistor portion of the fifth heat generating portion in the second direction crossing the first direction is wider than a width of the second resistor portion of the fifth heat generating portion, the first resistor portion of the sixth heat generating portion, and the second resistor portion of the sixth heat generating portion in the second direction.

18. The substrate according to claim 10, wherein each of the plurality of heat generating portions comprises a first resistor portion which is located between the first connecting portion and the third connecting portion and whose width in a second direction crossing the first direction is different from that of the first connecting portion and the third connecting portion, and a second resistor portion which is located between the second connecting portion and the third connecting portion and whose width in the second direction is different from that of the second connecting portion and the third connecting portion,
the plurality of heat generating portions include a fifth heat generating portion and a sixth heat generating portion,
a length of the first resistor portion of the fifth heat generating portion is shorter than a length of the second resistor portion of the fifth heat generating portion, a length of the first resistor portion of the sixth heat generating portion, and a length of the second resistor portion of the sixth heat generating portion, and
a width of the first resistor portion of the fifth heat generating portion in the second direction crossing the first direction is narrower than a width of the second resistor portion of the fifth heat generating portion, the first resistor portion of the sixth heat generating portion, and the second resistor portion of the sixth heat generating portion in the second direction.

19. A liquid discharge head comprising:
the liquid discharge head substrate according to claim 1, and
a discharge port whose discharge of a liquid is controlled by the liquid discharge head substrate.

20. A liquid discharge apparatus comprising:
the liquid discharge head according to claim 19, and
a unit configured to supply, to the liquid discharge head, a driving signal discharging a liquid.
